(19) United States
(12) Patent Application Publication
(10) Pub. No.: US 2017/0030342 A1
(43) Pub. Date: Feb. 2, 2017

(54) Cryogenic Pump Heater

(71) Applicant: Caterpillar Inc., Peoria, IL (US)

(72) Inventors: Cory A. Brown, Peoria, IL (US); Robert M. Campion, Chillicothe, IL (US)

(73) Assignee: CATERPILLAR INC., Peoria, IL (US)

(21) Appl. No.: 14/811,324

(22) Filed: Jul. 28, 2015

(51) Int. Cl. F04B 15/08; F17C 7/02; F04B 53/18

(52) U.S. Cl. CPC F04B 15/08; F04B 53/18; F17C 7/02; F04B 2015/081

(57) ABSTRACT

A pump for pumping a cryogenic fluid includes an activation portion that includes at least one actuator. The activation portion contains oil that may be cooled by the cryogenic fluid. The pump further includes a pumping portion that includes at least one pumping element, the at least one pumping element being operated by the at least one actuator, and a heater associated with the activation portion and configured to, when the heater is active, transfer heat energy to the activation portion such that the oil contained in the activation portion is warmed.

### TECHNICAL FIELD

This patent disclosure relates generally to pumps and, more particularly, to cryogenic fuel pumps for mobile applications.

### BACKGROUND

Many large mobile machines such as mining trucks, locomotives, marine applications and the like have recently begun using alternative fuels, alone or in conjunction with traditional fuels, to power their engines. For example, large displacement engines may use a gaseous fuel, alone or in combination with a traditional fuel such as diesel, to operate. Because of their relatively low densities, gaseous fuels, for example, natural gas or petroleum gas, are carried onboard vehicles in liquid form. These liquids, the most common including liquefied natural gas (LNG) or liquefied petroleum gas (LPG), are cryogenically stored in insulated tanks on the vehicles, from where a desired quantity of fuel is pumped, evaporated, and provided to fuel the engine.

The pumps that are typically used to deliver the LNG to the engine of the machine include pistons, which deliver the LNG to the engine. For example, while LNG may be stored at a pressure of about 300 psi, CNG for use by the engine may be provided at about 35 MPa or higher. Such piston pumps, which are sometimes also referred to as cryogenic pumps, will often include a single piston that is reciprocally mounted in a cylinder bore. The piston is moved back and forth in the cylinder to draw in and then compress the gas. Power to move the piston may be provided by different means, the most common being electrical, mechanical or hydraulic power.

One example of a cryogenic pump can be found in U.S. Pat. No. 7,293,418 (the '418 patent), which describes a cryogenic, single-element pump for use in a vehicle. The pump discharges into an accumulator that is located within the tank, and uses a single piston pump that is connected to a drive section via a piston rod. The drive section is disposed outside of the tank.

In pumps such as the pump described in the '418 patent, when the pump is not in operation, conductive heat loss into the cryogenic fluid that contacts one end of the pump can cause thermal issues in the actuation portion of the pump, especially if pressurized hydraulic fluid is used to activate the pumping portion of the pump. In non-hydraulic applications, thermal issues may also be manifested as coagulation of lubricating oil that is present between various moving parts of the pump. Such loss in lubrication ability, and also a degradation of fluid used to actuate the pump, can cause, at least temporarily, reduced performance and increased wear in pump components, particularly under operating conditions when the pump actuator has not reached its normal operating temperature such as during a start after a cold soak condition.

### SUMMARY

The present disclosure is generally directed to an auxiliary heater that is associated with a pump for pumping cryogenic fluid. The heater may be disposed between a warm section of the pump, which includes lubricating or actuating oil, and a cold section of the pump, which contacts the cryogenic fluid.

The disclosure, therefore, describes, in one aspect, a pump for pumping a cryogenic fluid. The pump includes an activation portion that includes at least one actuator and that contains oil. The pump further includes a pumping portion that includes at least one pumping element, the at least one pumping element being operated by at least one actuator, and a heater associated with the activation portion. The heater is configured to transfer heat energy to the activation portion such that the oil contained in the activation portion is warmed when the heater is active.

In another aspect, the disclosure describes a method for operating a pump. The method includes providing an activation portion that includes at least one actuator, the activation portion containing oil, providing a pumping portion that includes at least one pumping element, the at least one pumping element being operated by the at least one actuator, and providing a heater associated with the activation portion. The pump is placed within a cryogenic fluid storage tank such that the pumping portion is immersed in a cryogenic fluid, and cooling of the oil contained in the activation portion of the pump is prevented by activating the heater to warm the oil contained in the activation portion of the pump.

In yet another aspect, the disclosure describes a fuel system for an engine. The fuel system includes a cryogenic fluid storage tank containing a fuel, a hollow sleeve extending into an interior of the cryogenic fuel storage tank, and a pump having a generally cylindrical shape and disposed within the hollow sleeve. The pump forms an activation portion that includes at least one actuator, the activation portion containing oil, a pumping portion that includes at least one pumping element, the at least one pumping element being operated by the at least one actuator and extending into the fuel, and a heater associated with the activation portion. The heater is configured to transfer heat energy to the activation portion such that the oil contained in the activation portion is warmed when the heater is active. The fuel system further includes an electronic controller associated with the heater and programmed to activate the heater to preheat the pump before the pump is operated.

### BRIEF DESCRIPTION OF THE DRAWINGS

FIG. 1 is a block diagram of an engine system having a compressed gas fuel system that includes a gaseous fuel storage tank and corresponding fuel pump in accordance with the disclosure.

FIG. 2 is a section view of a cryogenic pump in accordance with the disclosure installed into a cryogenic fluid storage tank.

FIG. 3 is an outline view of a pump having a heater in accordance with the disclosure.

FIG. 4 is a flowchart for a method of operating a pump in accordance with the disclosure.

### DETAILED DESCRIPTION

The present disclosure is applicable to pumps for pumping a fluid such as cryogenically or otherwise pressurized gaseous fuel stored in liquid form on-board a machine for various mobile or stationary applications. In the disclosed, exemplary pump embodiments, the architecture of the pump allows it to use oil for lubrication and/or actuation purposes, the viscosity of which oil may be affected, for example, when the pump is not operating, by thermal effects such as cooling by the cryogenic fluid that is in contact with at least a portion of the pump. In certain applications, it is desired to mount the pump in close proximity to the pumped cryogenic fluid, for example, by mounting the pump within a sleeve extending into the cryogenic fluid storage tank. In this way, the overall heat transfer to the cryogenic fluid can be reduced, and pump efficiency can be increased by improving the net positive suction head of the pumping elements of the pump. Several variations of cryogenic pumps are contemplated, including pumps having a single pumping element that is mechanically or electrically activated, single or multiple pumping elements having a hydraulic actuation configuration powering plungers of the pump that pump the cryogenic fluid, and/or mechanically actuated pumps having a single or multiple pumping element(s) that are activated by a nutator or swash-plate and tappet/follower arrangements. In any pump type, oil may be used in the actuation mechanism of the pump either solely for lubrication or moving and/or sliding components or, additionally, for providing a hydraulic actuation force for the pumping elements.

The present disclosure relates to engines using a gaseous fuel source such as direct injection gas (DIG) or indirect injection gas engines using diesel or spark ignition. More particularly, the disclosure relates to an embodiment for an engine system that includes a gaseous fuel storage tank having a pump that supplies cryogenically stored fluid to fuel an engine. The illustrated pump can be hydraulically actuated, but the various embodiments discussed herein are equally applicable to pumps having other actuation mechanisms.

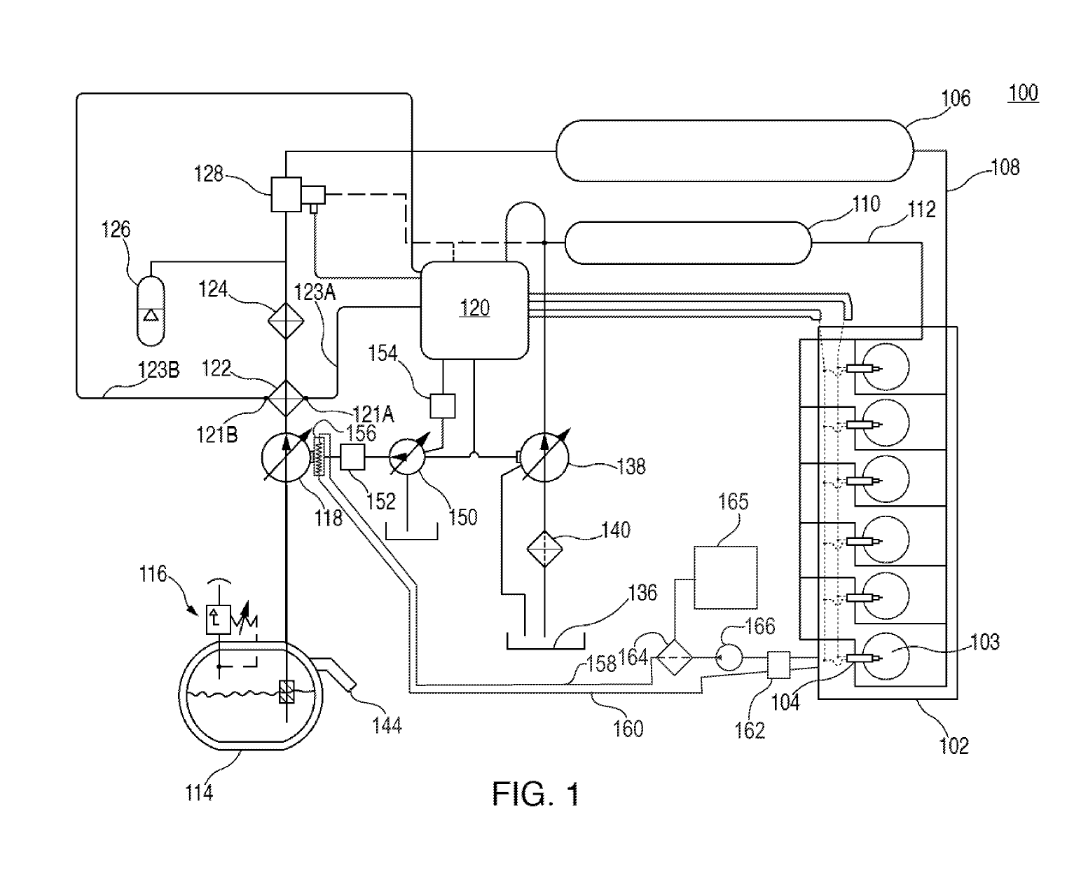

A block diagram of a DIG, engine system 100, which in the illustrated embodiment uses diesel as the ignition source, is shown in FIG. 1, but it should be appreciated that indirect injection engines, and/or engines using a different ignition mode are contemplated. The engine system 100 includes an engine 102 (shown generically in FIG. 1) having a fuel injector 104 associated with each engine cylinder 103. The fuel injector 104 can be a dual-check injector configured to independently inject predetermined amounts of two separate fuels, in this case, diesel and gas, into the engine cylinders.

The fuel injector 104 is connected to a high-pressure gaseous fuel rail 106 via a high-pressure gaseous fuel supply line 108 and to a high-pressure liquid fuel rail 110 via a liquid fuel supply line 112. In the illustrated embodiment, the gaseous fuel is natural or petroleum gas that is provided through the high-pressure gaseous fuel supply line 108 at a pressure of between about 10-50 MPa, and the liquid fuel is diesel, which is maintained within the high-pressure liquid fuel rail 110 at about 15-100 MPa, but any other pressures or types of fuels may be used depending on the operating conditions of each engine application. It is noted that although reference is made to the fuels present in the high-pressure gaseous fuel supply line 108 and the high-pressure liquid fuel rail 110 using the words “gaseous” or “liquid,” these designations are not intended to limit the phase in which is fuel is present in the respective rail and are rather used solely for the sake of discussion of the illustrated embodiment. For example, the fuel provided at a controlled pressure within the high-pressure gaseous fuel supply line 108, depending on the pressure at which it is maintained, may be in a liquid, gaseous or supercritical phase. Additionally, the liquid fuel can be any hydrocarbon based fuel; for example DME (Di-methyl Ether), biofuel, MDO (Marine Diesel Oil), or HFO (Heavy Fuel Oil).

Whether the engine system 100 is installed in a mobile or a stationary application, each of which is contemplated, the gaseous fuel may be stored in a liquid state in a tank 114, which can be a cryogenic storage tank that is pressurized at a relatively low pressure, for example, atmospheric, or at a higher pressure. In the illustrated embodiment, the tank 114 is insulated to store liquefied natural gas (LNG) at a temperature of about −160° C. (−256° F.) and a pressure that is between about 100 and 1750 kPa, but other storage conditions may be used. The tank 114 further includes a pressure relief valve 116 and a fill port 144. The fill port 144 may include special or appropriate features for interfacing with a compressed natural gas (CNG) and/or liquid petroleum gas (LPG) or liquefied natural gas (LNG) fill hose or valve. In the description that follows, a DIG engine system embodiment is used for illustration, but it should be appreciated that the systems and methods disclosed herein are applicable to any machine, vehicle or application that uses cryogenically stored gas, for example, a locomotive in which the tank 114 may be carried in a tender car.

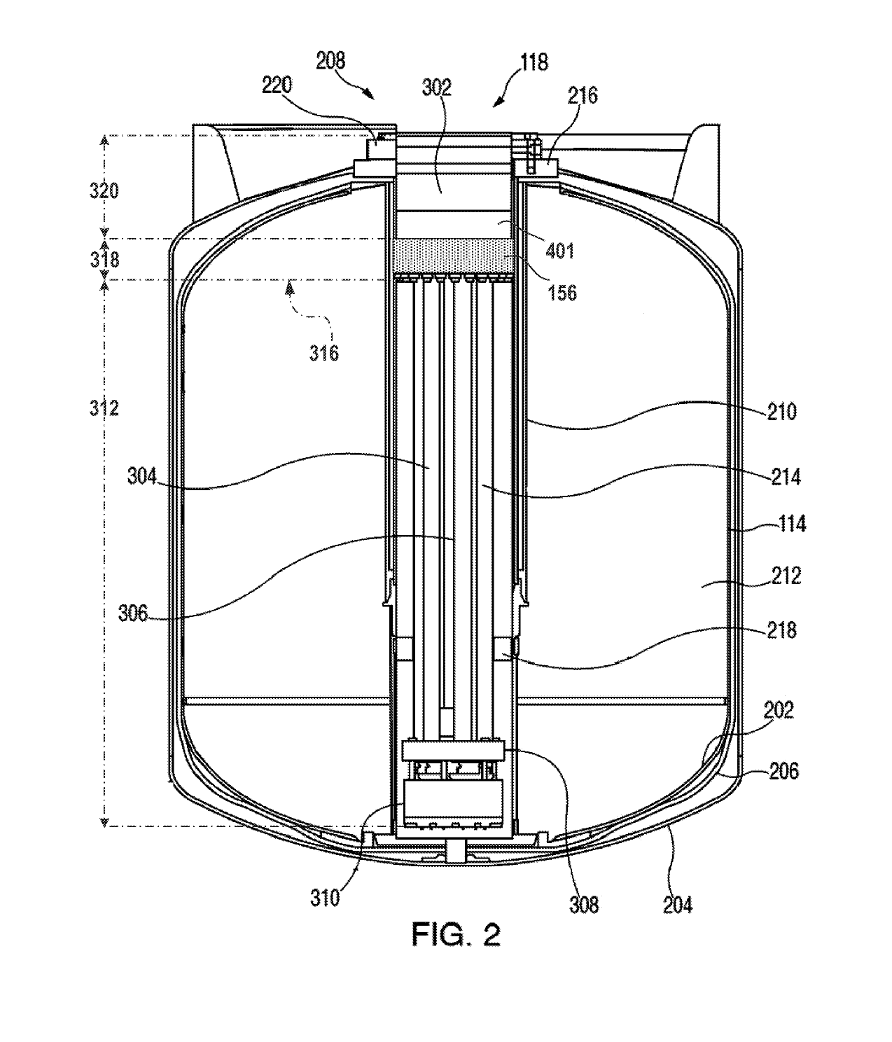

Relative to the particular embodiment illustrated, during operation, LNG from the tank is pressurized, still in a liquid phase, in a pump 118, which raises the pressure of the LNG while maintaining the LNG in a liquid phase. The pump 118 is configured to selectively increase the pressure of the LNG to a pressure that can vary in response to a pressure command signal provided to the pump 118 from an electronic controller 120. The pump 118 is shown external to the tank 114 in FIG. 1 for illustration, but it is contemplated that the pump 118 may at least partially be disposed within the tank 114, as is illustrated in the figures that follow, for example, in FIG. 2. Although the LNG is present in a liquid state in the tank, the present disclosure will make reference to compressed or pressurized gas for simplicity when referring to gas that is present at a pressure that exceeds atmospheric pressure.

The pressurized LNG provided by the pump 118 is heated in a heat exchanger 122. The heat exchanger 122 provides heat to the compressed LNG to reduce density and viscosity while increasing its enthalpy and temperature. In one exemplary application, the LNG may enter the heat exchanger 122 at a temperature of about −160° C., a density of about 430 kg/m³, an enthalpy of about 70 kJ/kg, and a viscosity of about 169 μPa s as a liquid, and exit the heat exchanger at a temperature of about 50° C., a density of about 220 kg/m³, an enthalpy of about 760 kJ/kg, and a viscosity of about 28 μPa s. It should be appreciated that the values of such representative state parameters may be different depending on the particular composition of the fuel being used. In general, the fuel is expected to enter the heat exchanger in a cryogenic, liquid state, and exit the heat exchanger in a supercritical gas state, which is used herein to describe a state in which the fuel is gaseous but has a density that is between that of its vapor and liquid phases.

The heat exchanger 122 may be any known type of heat exchanger or heater for use with LNG. In the illustrated embodiment, the heat exchanger 122 is a jacket water heater that extracts heat from engine coolant. In alternative embodiments, the heat exchanger 122 may be embodied as an active heater, for example, a fuel fired or electrical heater, or may alternatively be a heat exchanger using a different heat source, such as heat recovered from exhaust gases of the engine 102, a different engine belonging to the same system such as what is commonly the case in locomotives, waste heat from an industrial process, and other types of heaters or heat exchangers such as ambient air fin or tube heat exchangers. In the embodiment shown in FIG. 1, which uses engine coolant as the heat source for the heat exchanger 122, a pair of temperature sensors 121A and 121B are disposed to measure the temperature of engine coolant entering and exiting the heat exchanger 122 and provide corresponding temperature signals 123 to the electronic controller 120.

Liquid fuel, or in the illustrated embodiment diesel fuel, is stored in a fuel reservoir 136. From there, fuel is drawn into a variable displacement pump 138 through a filter 140 and at a variable rate depending on the operating mode of the engine. The rate of fuel provided by the variable displacement pump 138 is controlled by the pump's variable displacement capability in response to a command signal from the electronic controller 120. Pressurized fuel from the variable displacement pump 138 is provided to the high-pressure liquid fuel rail 110. Similarly, the pump 118 has a variable supply capability that is responsive to a signal from the electronic controller 120.

Gas exiting the heat exchanger 122 is filtered at a filter 124. As can be appreciated, the gas passing through the filter 124 may include gas present in more than one phase such as gas or liquid. An optional gas accumulator 126 may collect filtered gas upstream of a pressure regulator 128 that can selectively control the pressure of gas provided to a gas manifold 106 that is connected to the high-pressure gaseous fuel supply line 108. To operate the pump 118, a hydraulic pump 150 having a variable displacement and selectively providing pressurized hydraulic fluid to the pump 118 via a valve system 152 is used. Operation of the hydraulic pump 150 is controlled by an actuator 154 that responds to commands from the electronic controller 120.

A fragmented view of the tank 114 having the pump 118 at least partially disposed therein is shown in FIG. 2. The tank 114 may include an inner wall 202, which contains the pressurized LNG, and an outer wall 204. A layer of insulation 206 may be disposed along a gap between the inner wall 202 and the outer wall 204. Both the inner wall 202 and the outer wall 204 have a common opening 208 at one end of the tank, which surrounds a cylindrical casing 210 that extends into a tank interior 212. The cylindrical casing 210 is hollow and defines a pump bore 214 therein that extends from a mounting flange 216 into the tank interior 212 and accommodates the pump 118 therein. A seal 218 separates the interior of the tank 212 from the common opening 208, as shown, around the mounting flange 216, along the pump bore 214.

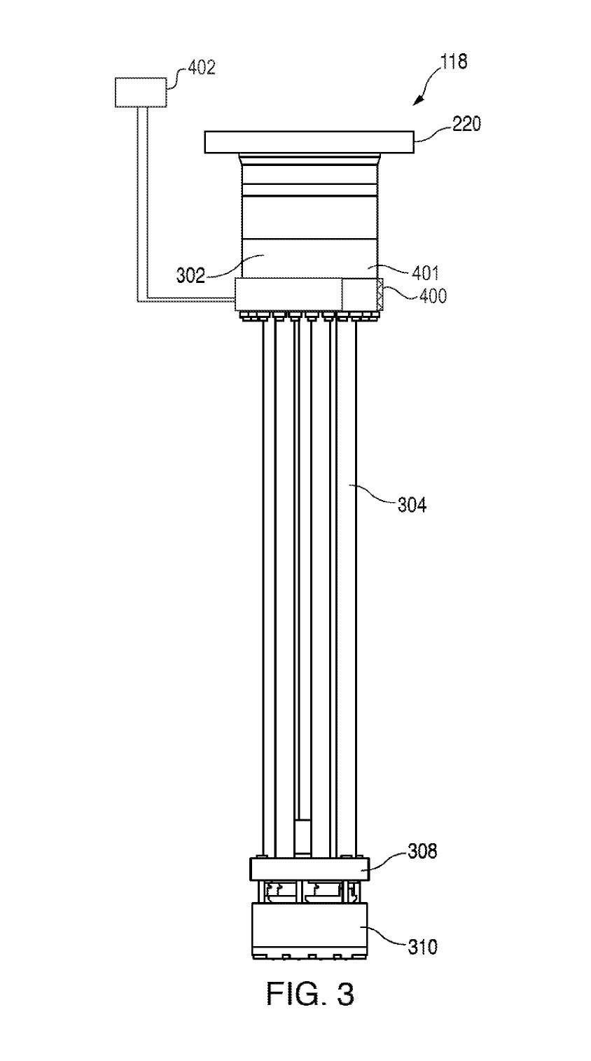

The pump 118 in the illustrated embodiment has a generally cylindrical shape and includes a pump flange 220 that supports the pump 118 on the mounting flange 216 of the tank 114. An outline view of the pump 118, removed from the tank 114, is also shown in FIG. 3. The pump 118 generally includes an actuator portion 302 that operates to selectively actuate one or more pushrods 304. The pushrods 304, which are caused to reciprocate during operation by the actuator portion 302, extend from the actuator portion 302 to an actuation portion 308 that is associated with a pumping portion 310. During operation, the pumping portion 310, which may be immersed in cryogenic fluid, operates to pump fluid from the tank interior 212 out of the tank and through an outlet or pump discharge to supply the engine with fuel, as previously described. The pumping portion 310 is actuated for pumping fluid by the actuation portion 308, which in turn translates the reciprocal motion of the pushrods 304 into a pumping action that operates the pumping portion 310.

The pump 118 advantageously includes six pumping elements, but another number of pumping elements (there could be, for example, one, two, three, four, five, seven, etc. pumping elements) can be used, depending on the application. In the illustrated embodiment, six pumping elements, each with its own set of components, are disposed in diametrically opposed pairs symmetrically around the pump. Tappets that actuate the pushrods may be housed in a tappet housing 401 that forms bores symmetrically around the pump and supports or otherwise accommodates the various other components of the pump 118. The electronic controller 120 is configured and programmed to selectively actuate each pumping element by sending and appropriate command, at a desired time and for a desired duration. In a mechanically actuated pump embodiment, the various pumping elements can be sequentially actuated by a nutator.

As shown in FIG. 2, a bottom portion of the pump that includes the pumping portion 310 may be submerged in cryogenic fluid, which fluid level may further expose a certain length of the pushrods 304 up to the seal 218. As can be appreciated, direct contact of the cryogenic fluid with the bottom portion of the pump 118 will decrease the temperature of those pump portions contacting the fluid to be about the same or slightly higher than the cryogenic temperature of the fluid. This temperature decrease will act to, at least via conduction, draw heat from the upper portion of the pump that includes the actuator portion 302. During operation, friction and actuation fluids provided under pressure to the actuator portion 302 provide heat to the actuator portion 302. However, when the pump is not operating, and especially for cold ambient conditions, the upper portion of the pump may be cold saturated, which may cause lubrication and/or actuation fluids found therein, for example, oil and/or hydraulic fluid, to become more viscous and, in certain conditions, coagulate.

In reference now to FIG. 1, to help warm the lubricated portions of the pump, a heater 156 is disposed adjacent a hydraulic actuation portion of the pump 118 (also see FIG. 2). In the illustrated embodiment, the heater 156 is embodied at a liquid heat exchanger that is connected to a coolant supply line 158 and to a coolant return line 160 that are configured to circulate a flow of coolant through the heater 156. When the coolant is warmed, the coolant can heat the actuation portion of the pump by heat transfer through the heater 156. In the illustrated embodiment, the coolant lines 158 and 160 are connected to the engine 102 so they can draw heat from the engine's coolant system via a flow regulator 162. The flow regulator 162 can route coolant from the engine 102 to and from the heater 156, or may alternatively create a closed coolant circuit that includes the heater 156 as well as a coolant heater 164 and a circulation pump 166. Under cold starting conditions of the engine 102, before the engine coolant has sufficiently warmed, the flow regulator 162 can isolate the circuit that includes the heater 156 and activate the coolant heater 164 to heat the coolant, which is circulated through the heater 156 by the pump 166. The coolant heater 164 is connected to a power source such as a battery 165 that provides electrical power to heat the coolant passing through the coolant heater 164.

A particular embodiment for the placement of the heater 156 is shown in FIG. 2. In this embodiment, the heater 156 is formed as a plate and is disposed between the tappet housing 401 and the pushrods 304. A support rod 306 extends between the pushrods 304. During operation of the heating system, while the engine may operate or before the engine is operating, warm coolant or, in an alternative embodiment, electrically heated elements, may conductively heat the various internal components in the activation portion 302 and the tappet housing 401. The placement of the heater 156 in this location places the heater at a junction along the pump 118 where cold and warm portions meet. Specifically, a lower, cold portion 312 of the pump is disposed within the tank and at least partially in contact with the cryogenic fluid such that it is cooled by the fluid and acts as a heat sink. An upper, warm portion 314 includes the activation portion 302 and other structures that operate the pushrods 304. At an interface 316 between the warm portion 314 and the cold portion 312 is the lowest point on the pump 118 where oil may be found, for example, to lubricate the slidable interface with the pushrods 304, and it is here where the heater 156 may be disposed to be most effective in avoiding issues of low temperature. As shown, therefore, the heater 156 may create an insulative and heating zone 318 to act as a buffer for heat transfer and to also help add heat energy into the actuation portion 302 in a heated zone 320 of the pump.

An alternative embodiment for a heater 400 is shown in FIG. 3 disposed on the pump 118, which is shown removed from the tank for clarity. The heater 400 is an electrically powered heater that draws electrical power from a power module 402 that can include a power source such as a battery as well as suitable switches and monitors that are responsive to controller commands to activate the heater 400 when desired. As shown, the heater 400 may include resistive materials that convert electrical current to heat, but other heater types may be used.

As shown in FIG. 3, the heater 400 has a generally cylindrical shape that wraps around a lower portion of the tappet housing 401 and extends peripherally around the pump 118 to provide a generally uniform heat influx to the various pump components. Activation of the heater may be carried out as part of an engine startup sequence to heat the various portions and internal components of the pump, preferably before the pump begins to operate and also, optionally, during an initial period of pump operation.

### INDUSTRIAL APPLICABILITY

The present disclosure is applicable to any type of application that involves a cryogenic storage tank. In the illustrated embodiment, a land vehicle having a LNG or LPG fuel source that is carried in an on-board tank was used for illustration, but those of ordinary skill in the art should appreciate that the methods and systems described herein have universal applicability to any type of cryogenic gas tank that includes a pump for pumping liquefied gas from the tank to supply a system such as an engine with gas.

In general, the heater use and its location on the pump that are described herein are intended to prevent frozen, viscous or coagulated oil and/or hydraulic fluid from clogging the pump. The described heaters are located near the lowest point in the pump that oil could get to. Before operating a cold-soaked pump, the heater would be used for a pre-determined amount of time to liquefy oil in the pump such that, once the oil viscosity is low enough to flow, the pump could be operated normally.

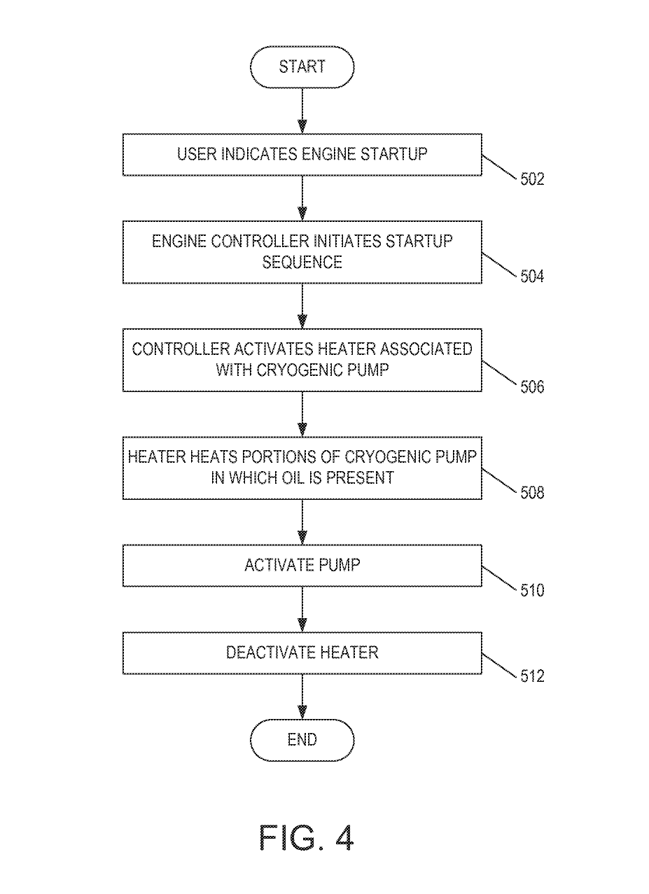

A flowchart for a method of operating a pump having a heater is shown in FIG. 4. In accordance with the process, a startup indication for an engine may be given by a user at 502, and a startup sequence may be initiated at 504. As part of the startup sequence, a heater may be activated at 506. The heater may operate to heat various components of a cryogenic pump including those portions of the pump in which oil and/or hydraulic fluid may be present at 508. When the oil and/or hydraulic fluid has sufficiently warmed, so it can freely flow, the pump may be activated at 510 and the heater, before or after pump activation, may be deactivated at 512. Alternative embodiments of the process include continuously monitoring a temperature associated with internal pump components while the pump and engine are active or inactive, and activating the heater to maintain a temperature above a low threshold temperature for internal pump components, which can shorten the startup sequence of the engine because the pump will require little to no pre-warming.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A pump for pumping a cryogenic fluid, comprising:
an activation portion that includes at least one actuator, the activation portion containing oil;
a pumping portion that includes at least one pumping element, the at least one pumping element being operated by the at least one actuator; and
a heater associated with the activation portion and configured to, when the heater is active, transfer heat energy to the activation portion such that the oil contained in the activation portion is warmed.

2. The pump of claim 1, further comprising at least one pushrod disposed between the at least one actuator and the at least one pumping element, the at least one pushrod operating to transfer motion from the at least one actuator to operate the at least one pumping element.

3. The pump of claim 1, wherein the oil contained in the activation portion is oil used to lubricate moving and sliding components within the activation portion.

4. The pump of claim 1, wherein the at least one actuator is a hydraulic actuator and wherein the oil contained in the activation portion is hydraulic oil used to provide a hydraulic force input to the at least one actuator.

5. The pump of claim 1, wherein the heater is an electrically operated heater that is connected to a power module and arranged to be activated by a controller.

6. The pump of claim 5, wherein the controller is programmed to activate the heater during a startup sequence of the pump.

7. The pump of claim 1, wherein the heater is a liquid heater operating to transfer heat from a flow of engine coolant to the activation portion.

8. The pump of claim 7, wherein the engine coolant circulates in a closed circuit that includes a circulation pump and a coolant heater operating to provide the heat to the flow of coolant.

9. The pump of claim 1, wherein the pump has a generally elongate cylindrical shape and wherein the pump is configured to be disposed within a sleeve, the sleeve being disposed within a cryogenic fluid storage tank such that the pumping portion is immersed in cryogenic fluid.

10. The pump of claim 9, wherein the heater has a hollow cylindrical shape that is disposed around a portion of the activation portion that is closest to the pumping portion while the pump is mounted within the sleeve.

11. The pump of claim 1, wherein the cryogenic fluid is liquefied natural gas (LNG).

12. A method for operating a pump, comprising:
providing an activation portion that includes at least one actuator, the activation portion containing oil;
providing a pumping portion that includes at least one pumping element, the at least one pumping element being operated by the at least one actuator; and
providing a heater associated with the activation portion;
placing the pump within a cryogenic fluid storage tank such that the pumping portion is immersed in a cryogenic fluid; and
preventing a cooling of the oil contained in the activation portion of the pump by activating the heater to warm the oil contained in the activation portion of the pump.

13. The method of claim 12, further comprising using the oil contained in the activation portion to lubricate moving and sliding components within the activation portion when the pump is operating.

14. The method of claim 12, further comprising using the oil contained in the activation portion to provide a hydraulic force input to the at least one actuator.

15. The method of claim 12, wherein the heater is an electrically operated heater that is connected to a power module and arranged to be activated by a controller.

16. The method of claim 15, further comprising activating the heater during a startup sequence of the pump and before operating the pump.

17. The method of claim 12, wherein the heater is a liquid heater operating to transfer heat from a flow of engine coolant to the activation portion.

18. The method of claim 17, further comprising circulating the engine coolant in a closed circuit that includes a circulation pump and a coolant heater operating to provide the heat to the flow of coolant.

19. The method of claim 12, wherein the pump has a generally elongate cylindrical shape, wherein the pump is configured to be disposed within a sleeve, the sleeve being disposed within a cryogenic fluid storage tank such that the pumping portion is immersed in cryogenic fluid, and wherein the heater has a hollow cylindrical shape that is disposed around a portion of the activation portion that is closest to the pumping portion while the pump is mounted within the sleeve.

20. A fuel system for an engine, comprising:
a cryogenic fluid storage tank containing a fuel;
a hollow sleeve extending into an interior of the cryogenic fuel storage tank;
a pump having a generally cylindrical shape and disposed within the hollow sleeve, the pump forming an activation portion that includes at least one actuator, the activation portion containing oil, a pumping portion that includes at least one pumping element, the at least one pumping element being operated by the at least one actuator and extending into the fuel; and a heater associated with the activation portion and configured to, when the heater is active, transfer heat energy to the activation portion such that the oil contained in the activation portion is warmed; and
an electronic controller associated with the heater, the electronic controller programmed to activate the heater to preheat the pump before the pump is operated.
